(19) United States
(12) Patent Application Publication
(10) Pub. No.: US 2011/0223464 A1
(43) Pub. Date: Sep. 15, 2011

(54) Separator Systems for Batteries

(76) Inventors: Joseph J. Viavattine, Vadnais Heights, MN (US); John D. Norton, Saint Paul, MN (US); Christian S. Nielsen, River Falls, WI (US)

(21) Appl. No.: 13/112,265

(22) Filed: May 20, 2011

Related U.S. Application Data
(63) Continuation of application No. 11/363,731, filed on Feb. 28, 2006.

(51) Int. Cl. H01M 2/16; H01M 6/00

(52) U.S. Cl. 429/144; 29/623.1; 29/623.4

(57) ABSTRACT

A battery cell is presented. The battery cell includes an anode, a cathode spaced from and operatively associated with the anode, an electrolyte operatively associated with the anode and the cathode. A layered separator includes a plurality of separator material layers disposed between the anode and cathode. The plurality of separator material layers includes a first layer and a second layer. The first layer is characterized by a first value of a physical property and the second layer is characterized by a second value of the physical property.

### RELATED APPLICATIONS

This application is a continuation of U.S. application Ser. No. 11/363,731 filed Feb. 28, 2006 and entitled Separator Systems for Batteries the contents of which are incorporated by reference herein in its entirety.

### TECHNICAL FIELD

The present invention relates generally to electrochemical cells, and, more particularly, to configurations of separator systems for batteries in implantable medical devices.

### BACKGROUND

Implantable medical devices (IMDs) diagnose and deliver therapy to patients suffering from a variety of conditions. Examples of implantable medical devices include implantable pacemakers and implantable cardioverter-defibrillators (ICDs), which are electronic medical devices that monitor the electrical activity of the heart and provide electrical stimulation to one or more of the heart chambers as necessary. Pacemakers deliver relatively low-voltage pacing pulses in one or more heart chambers. ICDs can deliver high-voltage cardioversion and defibrillation shocks in addition to low-voltage pacing pulses

Pacemakers and ICDs generally include pulse generating circuitry required for delivering pacing and/or cardioversion and defibrillation pulses, control circuitry, telemetry circuitry, and other circuitry that require an energy source, e.g. at least one battery. In addition to a battery, ICDs include at least one high-voltage capacitor for use in generating high-voltage cardioversion and defibrillation pulses. IMDs, including pacemakers, ICDs, drug pumps, neurostimulators, physiological monitors such as hemodynamic monitors or ECG monitors, typically require at least one battery to power the various components and circuitry to perform the device functions.

IMDs are preferably designed with a minimal size and mass to minimize patient discomfort and prevent tissue erosion at the implant site. Batteries and capacitors, referred to collectively herein as “electrochemical cells,” contribute substantially to the overall size and mass of an IMD. Electrochemical cells used in IMDs are provided with an encasement for housing an electrode assembly, including an anode and cathode separated by a separator material, a liquid electrolyte, and other components such as electrode connector feed-throughs and lead wires. The encasement commonly includes a case and a cover that are hermetically sealed after assembling the cell components within the case.

Electrochemical cells that use a liquid electrolyte include separator material between anode and cathode elements to prevent shorting between the electrodes while still allowing ionic transport between the electrodes to complete the electrical circuit. Separators used in battery cells for use in IMDs have been formed from porous polymer films. The physical separator between the anode and cathode restricts mass transport between electrodes and therefore contributes to the equivalent series resistance (ESR) of the cell. ESR results in internal energy losses through resistance heating and is preferably minimized to improve cell efficiency. Typically two layers of kraft paper separator are required for adequate performance, resulting in a substantial contribution to ESR.

It is desirable to reduce electrochemical cell size and mass in order to reduce the size of the IMD. Reduction of electrochemical cell size or mass may allow balanced addition of volume to other IMD components, thereby increasing device longevity and/or increasing device functionality.

### BRIEF DESCRIPTION OF THE DRAWINGS

FIG. 1 depicts a perspective view of an implantable medical device (IMD) in which a battery cell includes a layered separator.

FIG. 2 is a block diagram of a control module for the IMD shown in FIG. 1.

FIG. 3 is a sectioned view of a portion of an electrode subassembly in the form of a laminate.

FIG. 4 is a perspective view of an electrode subassembly partially wrapped in a cylindrical coil configuration.

FIG. 5 is a perspective view of an electrode subassembly completely wrapped in a cylindrical coil configuration. (see comment on FIG. 4)

FIG. 6 is a perspective view of an electrode subassembly wrapped in a flat coil configuration.

FIG. 7 is a partial, side view of a stacked electrode subassembly formed using an anode/separator/cathode laminate.

FIG. 8 is a side view of a stacked electrode subassembly formed using separate anode, cathode and layered separator.

FIG. 9 is a side view of a stacked electrode subassembly formed using separate anode, cathode and a layered separator having differently sized separator layers.

FIG. 10 is a side view of a stacked electrode subassembly that includes a layered separator configured as one long strip of material wrapped around the electrode layers.

FIG. 11 is a side view of a layered separator that may be used in any of the electrochemical cell embodiments described herein.

FIG. 12A is a perspective view of a layered separator that includes two layers in which one layer is provided with a greater length than the other layer.

FIG. 12B is a perspective view of a layered separator having two layers that overlap over a portion of their inner surfaces.

FIG. 13 is a perspective, exploded view of a layered separator illustrating different orientations of separator layers.

FIG. 14 is a side sectional view of an alternative embodiment of a layered separator disposed between a cathode and an anode.

### DETAILED DESCRIPTION

The following description is merely exemplary in nature and is in no way intended to limit the invention, its application, or uses. For purposes of clarity, the same reference numbers are used in the drawings to identify similar elements. As used herein, the term “module” refers to an application specific integrated circuit (ASIC), an electronic circuit, a processor (shared, dedicated, or group) and memory that execute one or more software or firmware programs, a combinational logic circuit, or other suitable components that provide the described functionality.

The present invention is directed to an electrochemical cell that includes a separator formed from two or more layers of materials. As will be described herein, a layered separator includes two or more layers of materials that are selected based upon a physical property. Exemplary physical properties include material thickness, the resulting ESR, thermal properties, porosity, tortuosity, swelling rate, wettablility, defect density, tensile strength. In particular, the layered separator includes two or more dissimilar materials characterized by at least one differing physical property, which are layered together to form a separator having improved performance. The two or more layers of materials may be laminated together to form the layered separator. Alternatively, the two or more layers may be layered together without lamination.

In certain embodiments, the anode material, the cathode material and a layered separator are adhered together in an electrode sub-assembly. This electrode sub-assembly, commonly referred to as a “laminate,” is not to be confused with a laminated, layered separator which is provided as one component of a “laminate” electrode sub-assembly in various embodiments of the invention. As used herein, a “laminated separator” refers to any separator formed from two or more layers of materials that are bonded or adhered together along any portion of the layer surfaces disposed adjacent to each other. A “layered separator” is a separator that includes at least two layers of dissimilar materials, which may or may not be laminated together.

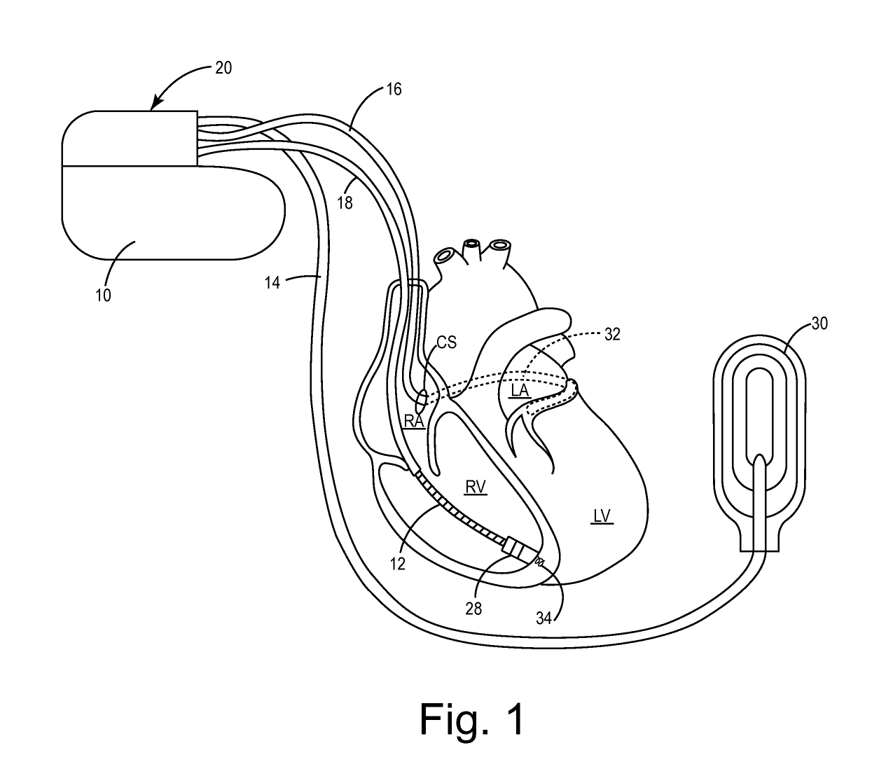

FIG. 1 illustrates one example of an implantable medical device (IMD) in which a battery cell including a layered separator may be utilized. IMD 10 is embodied as an implantable cardioverter-defibrillator (ICD) and is shown with associated electrical leads 14, 16 and 18 and their operative relationship to a human heart. Leads 14, 16 and 18 are coupled to IMD 10 by means of multi-port connector block 20, which contains separate connector ports for each lead 14, 16 and 18 Lead 14 is coupled to subcutaneous electrode 30, which is intended to be mounted subcutaneously in the region of the left chest. Lead 16 is a coronary sinus lead employing an elongated coil electrode 32 which is located in the coronary sinus and/or great cardiac vein region of the heart. The location of the coronary sinus electrode 32 may be anywhere along the heart from a point within the opening of the coronary sinus (CS) to a point in the vicinity of the left atrial appendage or left ventricle.

Lead 18 is provided with elongated coil electrode 12 which is disposed in the right ventricle of the heart. Lead 18 also includes a tip electrode 34 and ring electrode 28 available for pacing and sensing in the right ventricle. While one lead system having a particular electrode arrangement is shown in FIG. 1, numerous lead systems with varying electrode configurations are possible for use with an ICD or other IMDs used for delivering cardiac stimulation pulses.

In the system illustrated, cardiac pacing pulses can be delivered between tip electrode 34 and ring electrode 28. Electrodes 28 and 34 are also employed to sense electrical signals for detecting the heart rhythm. High-voltage defibrillation or cardioversion pulses may be delivered as needed using any of the right ventricular coil electrode 12, coil electrode 32 carried by coronary sinus lead 16, and subcutaneous patch electrode 30. In some embodiments, the housing of IMD 10 is used as a “case” or “can” electrode in combination with any of the high-voltage electrodes for delivering defibrillation or cardioversion shocks.

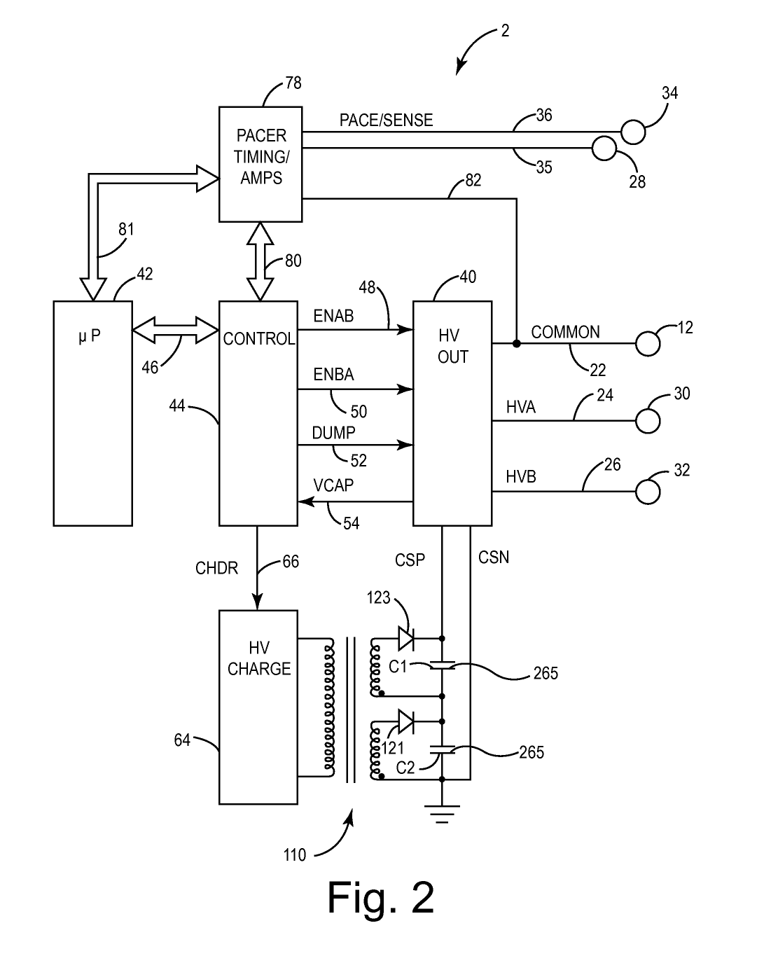

FIG. 2 is a functional block diagram of control module 2, illustrating the interconnection of high voltage output circuit 40, high voltage charging circuit 64 and capacitors 265. Control module 2 includes a microprocessor 42, which performs all necessary computational functions within IMD 10. Microprocessor 42 is linked to control circuitry 44 by means of bidirectional data/control bus 46, and thereby controls operation of the high voltage output circuitry 40 and the high voltage charging circuitry 64. On reprogramming of the device or on the occurrence of signals indicative of delivery of cardiac pacing pulses or of the occurrence of cardiac contractions, pace/sense circuitry 78 signals microprocessor 42 to perform any necessary mathematical determination (i.e. calculations), to perform tachycardia and fibrillation detection procedures and to update the time intervals controlled by the timers in pace/sense circuitry 78.

The basic operation of such a system in the context of an ICD may correspond to any system known in the art. Control circuitry 44 provides three signals to high voltage output circuitry 40. Those signals include the first and second control signals discussed above, labeled here as ENAB, line 48, and ENBA, line 50, and DUMP line 52 that initiates discharge of the output capacitors and VCAP line 54 which provides a signal indicative of the voltage stored on the output capacitors 265 to control circuitry 44. High voltage electrodes 12, 30 and 32 illustrated in FIG. 1, above, are shown coupled to output circuitry 40 by means of conductors 22, 24 and 26. For ease of understanding, those conductors are also labeled as “COMMON”, “HVA” and “HVB”. However, other configurations are also possible. For example, subcutaneous electrode 30 may be coupled to HVB conductor 26, to allow for a single pulse regimen to be delivered between electrodes 12 and 30. During a logic signal on ENAB, line 48, a cardioversion/defibrillation pulse is delivered between electrode 30 and electrode 12. During a logic signal on ENBA, line 50, a cardioversion/defibrillation pulse is delivered between electrode 32 and electrode 12.

The output circuitry includes a capacitor bank, including capacitors C1 and C2 labeled collectively as 265 and diodes 121 and 123, used for high-voltage pulses to the electrodes. Alternatively, the capacitor bank may include a further set of capacitors. In FIG. 2, capacitors 265 are illustrated in conjunction with high voltage charging circuitry 64, controlled by the control/timing circuitry 44 by means of CHDR line 66. As illustrated, capacitors 265 are charged by means of a high frequency, high voltage transformer 110. Proper charging polarities are maintained by means of the diodes 121 and 123. VCAP line 54 provides a signal indicative of the voltage on the capacitor bank, and allows for control of the high voltage charging circuitry and for termination of the charging function when the measured voltage equals the programmed charging level.

Pace/sense circuitry 78 includes a sense amplifier used for sensing R-waves. Pace/sense circuitry 78 also includes a pulse generator for generating cardiac pacing pulses, which may also correspond to any known cardiac pacemaker output circuitry and includes timing circuitry for defining pacing intervals, refractory intervals and blanking intervals, under control of microprocessor 42 via control/data bus 80.

Control signals triggering generation of cardiac pacing pulses by pace/sense circuitry 78 and signals indicative of the occurrence of R-waves, from pace/sense circuitry 78 are communicated to control circuitry 44 by means of a bi-directional data bus 80. Pace/sense circuitry 78 is coupled to tip electrode 34 and ring electrode 28, illustrated in FIG. 1, by respective conductors 35 and 36. Pace/sense circuitry 78 may also be coupled to right ventricular coil electrode 12, illustrated in FIG. 1, by a conductor 82, allowing for sensing of R-waves between electrodes 34 and 28 and for delivery of pacing pulses between electrodes 34 and 28.

Battery cells 265 include an anode, a cathode, an electrolyte operatively associated with the anode and the cathode, and a layered separator disposed between the anode and cathode. The layered separator prevents internal electrical short circuit conditions while allowing sufficient movement of the electrolyte within the cell. Battery cells 265 provide the charge necessary to HV output circuitry 40 for generating high voltage defibrillation/cardioversion shocks as needed.

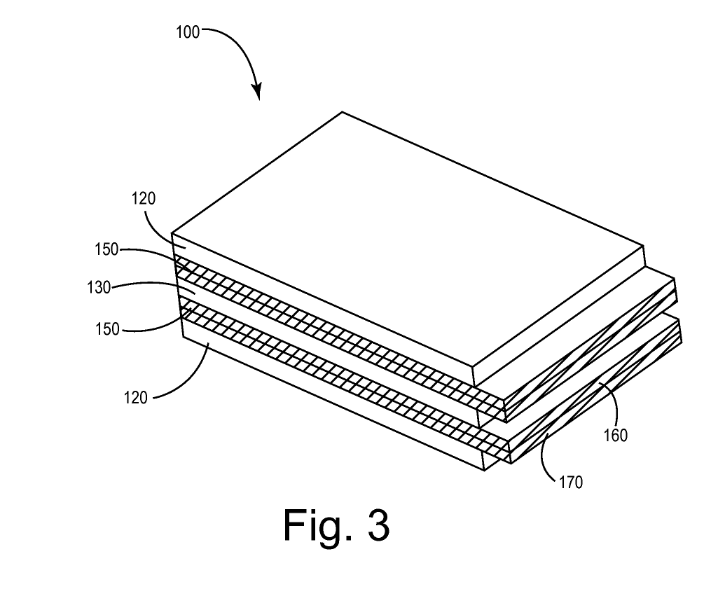

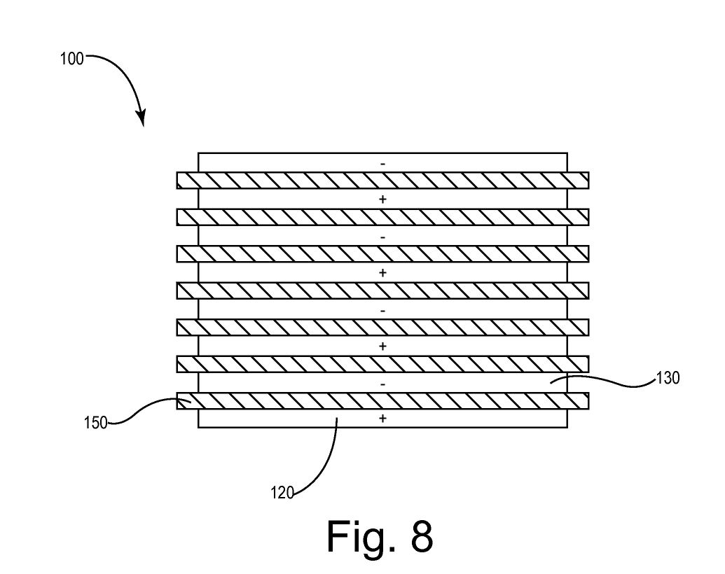

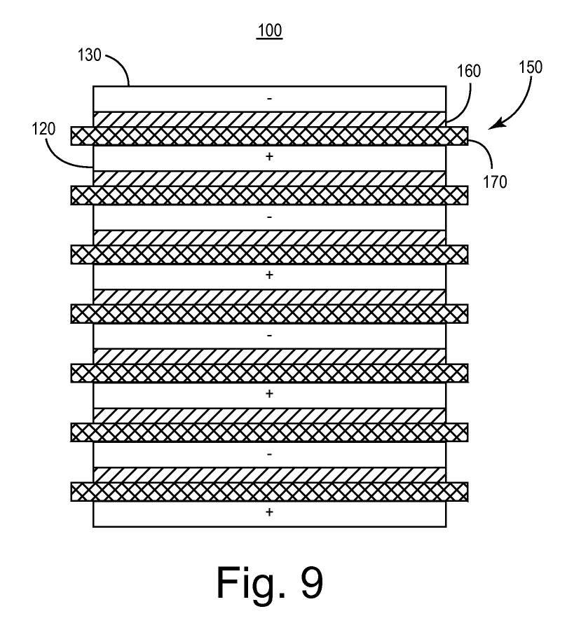

The anode, layered separator and cathode of the battery cells 265 can be configured together within an encasement or pre-assembled in an electrode subassembly in any suitable form. For example, an electrode sub-assembly can be arranged in a coiled configuration or a stacked configuration. In certain embodiments, the anode, layered separator, and cathode material can be configured together as a “laminate.” In other embodiments, the anode, separator, and cathode material can be configured as separate layers of material in a stack. In the following figures, FIGS. 3 through 7 show the anode, layered separator and cathode in a laminate form. FIGS. 8 and 9 show the anode, layered separator and cathode in a stacked form.

FIG. 3 shows a portion of an electrode subassembly in the form of a laminate. Generally, electrode subassembly 100 includes an anode 120, layered separator 150, and cathode 130, all of which may be adhered together to form an electrode subassembly laminate or envelope. These materials can be adhered together using a staking operation. The subassembly 100 can be made by adhering an anode 120 and cathode 130 to each side of the layered separator 150. FIG. 3 specifically shows an electrode subassembly 100 having an anode/separator/cathode/separator/anode configuration. However, it should be apparent to a skilled artisan that any number of anode, separator and cathode layers or strips of material can be used to form the electrode subassembly 100.

Separator 150 includes at least two layers 160 and 170. In one embodiment, separator layers 160 and 170 are aligned and layered together to form layered separator 50. In another embodiment, separator layers 160 and 170 are laminated together over at least a portion of the interfacing surfaces of adjacent layers 160 and 170 to form a laminated layered separator 150. As will be described in greater detail below, separator layers 160 and 170 are fabricated from two materials characterized by at least one differing physical property value. The two layers 160 and 170 collectively provide a layered separator 150 having the physical properties desired for improved battery cell performance and/or reduced volume. Accordingly, separator layers 160 and 170 may be formed from two dissimilar materials selected based on their physical properties. In some embodiments, separator layers 160 and 170 may be fabricated from the same material. In this embodiment, layers 160 and 170 comprise (PTFE, polypropylene, Kraft paper, not limited to this) and can be provided with different thicknesses and/or are oriented in different directions according to an anisotropic property of the material.

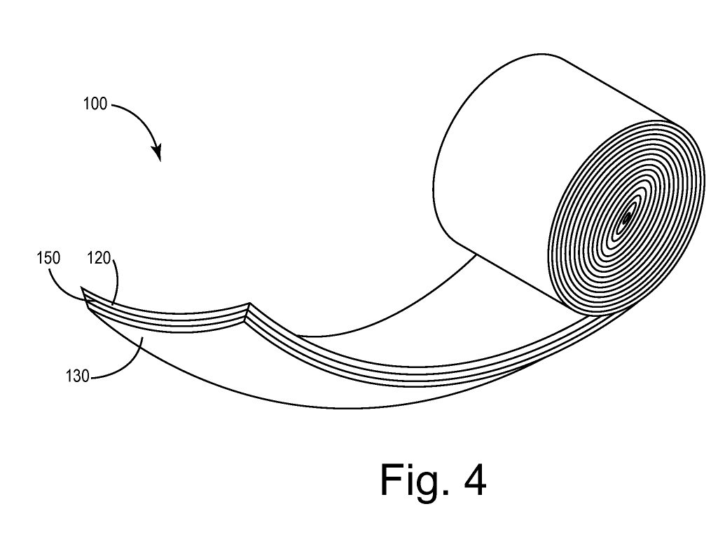

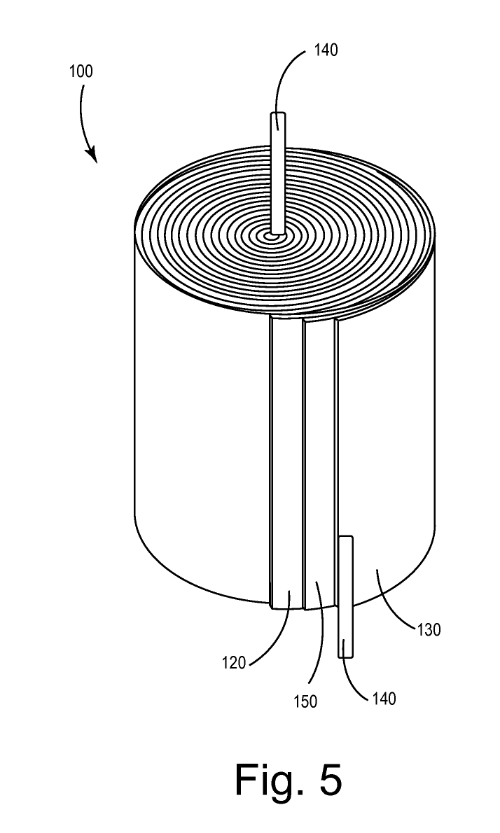

The electrode subassembly 100 can be coiled or wrapped within the battery cell in any suitable configuration. For example, FIG. 4 shows an electrode subassembly 100 partially wrapped in a cylindrical coil configuration. FIG. 5 shows the electrode subassembly 100 completely wrapped in a cylindrical coil configuration. Electrical connection tabs 140 are shown in FIG. 5, each extending from an anode 120 and a cathode 130. Electrical connection to anode 120 and cathode 130 may correspond to any known method such as cold welding, ultrasonic welding, resistance welding, laser welding, riveting, staking, etc.

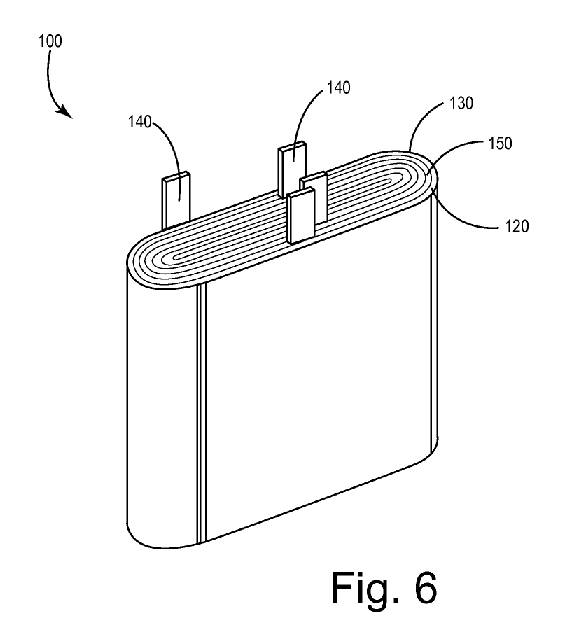

The coiled electrode subassembly 100 shown in FIG. 5 is not limited to the generally cylindrical coiled configuration as shown. For example, as shown in FIG. 6, the electrode subassembly 100 can be wrapped in a flat coil configuration. A flat coil configuration is generally better suited for positioning with other components within an IMD housing in a volumetrically efficient manner. FIG. 6 also shows electrical connection tabs 140 extending from anode 120 and cathode 130.

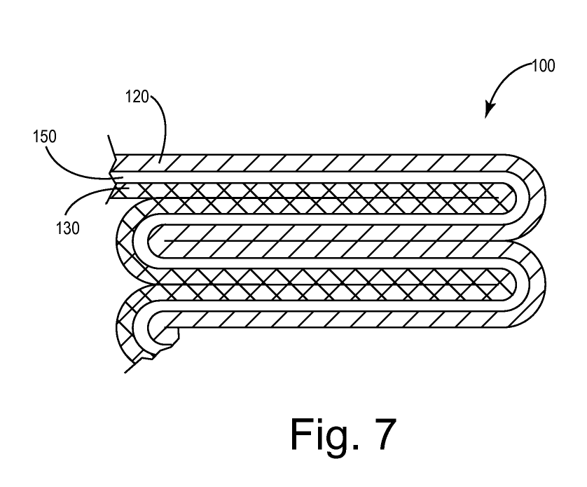

Likewise, while electrode subassemblies are often coiled, other non-coiled electrode subassembly configurations are available. For example, FIG. 7 shows a stacked electrode subassembly 100 formed using an anode/separator/cathode laminate. The anode/separator/cathode laminate is stacked by layering the laminate electrode subassembly 100 onto itself in a serpentine or Z-fold fashion. Stacked configurations of the electrode subassembly 100 can contribute to the volume efficiency of a battery cell.

FIGS. 8 and 9 show an electrode subassembly 100 formed using separate anode 120, cathode 130, and layered separator 150 layers rather than an anode/cathode/separator laminate. In these embodiments, each anode layer 20 and cathode layer 30 is a substantially rectangularly-shaped segments. However, it should be apparent that the anode layers 120 and cathode layers 130 can be configured in any suitable shape. The shapes of these layers are primarily a matter of design choice, and are dictated largely by the shape, size, or configuration of the encasement within which the electrode subassembly 100 is ultimately disposed. Each anode layer 120, cathode layer 130 and/or layered separator layer 150 can be formed into a specific, predetermined shape using die cutting or any other cutting or shaping methods known in the art.

In FIG. 8, layered separator 150 is configured as substantially rectangularly-shaped segments that are disposed in between each anode layer 120 and cathode layer 130. The layered separator segments 150 are typically longer than the anode 120 and cathode 130 to ensure that proper separation of the anode 120 and cathode 130 is maintained. In FIG. 9, separator layers 160 and 170 are shown to have different outer dimensions. One layer 170 of layered separator 150 extends beyond the boundaries of the electrodes 120 and 130 while the other layer 160 may have outer dimensions similar to the anode 120 and cathode 130. The extension of layer 170 beyond the outer dimensions of anode 120 and cathode 130 can ensure proper separation of the electrodes 120 and 130. Providing layer 160 with a smaller outer dimension than layer 170 improve volumetric efficiency without compromising separator 150 performance.

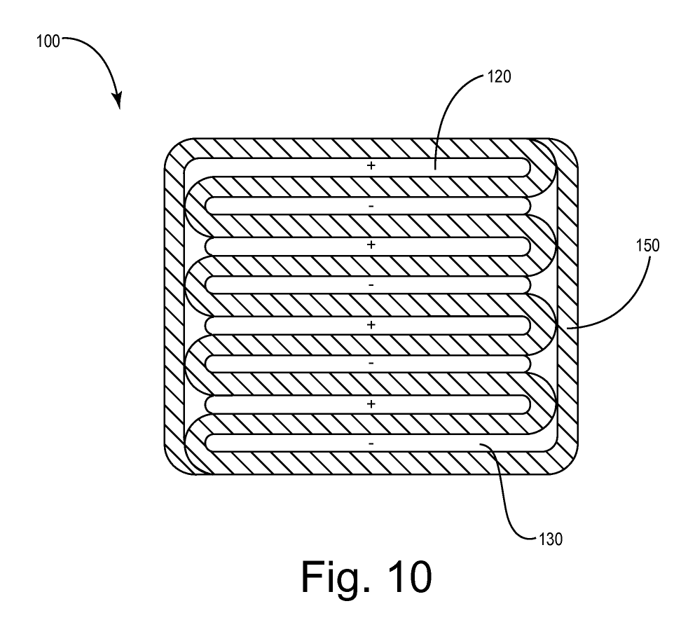

Alternatively, as shown in FIG. 10, the layered separator 150 is configured as one long strip of material that is wrapped around the electrode layers. It is recognized that the long strip of separator material can be wrapped around the electrode layers in any suitable manner. In other embodiments layered separator 150 may be formed into one or more pouches or envelopes, which may optionally be sealed closed, for surrounding anode 120 and/or cathode 130.

In the embodiments described herein, the anodes 120 and cathodes 130 of the battery cell are generally shown as a single layer of material. It is recognized that in certain embodiments, one or more of the anode layers and cathode layers in a stacked or coiled electrode sub-assembly may include multiple layers.

Skilled artisans understand that the length of the anode/separator/cathode electrode subassembly used or that the precise number of anode and cathode layers selected for use in a given battery cell will depend on the energy density, volume, voltage, current, energy output and other requirements of the device. Additionally, the precise number of notched and un-notched anode layers, anode tabs, anode sub-assemblies, and cathode layers selected for use in a given battery cell will depend upon the energy density, volume, voltage, current, energy output and other requirements placed upon the battery cell in a given application.

Battery cell components are typically sealed within an encasement including a case and a cover. The encasement may be fabricated from a corrosion-resistant metal such as stainless steel, aluminum, or titanium, or from a polymeric material. For liquid electrolyte cells that are typically used in IMDs, the cover is welded to the case to from a hermetic seal. The encasement is then filled with the liquid electrolyte. Electrolyte solutions can be based on inorganic acid such as sulfuric acid or based on solvents such as ethylene glycol or glycol ethers mixed with organic or inorganic acids or salts. Any suitable electrolyte known in the art may be used and depends on the particular cell chemistry and the reactivity with the anode and cathode material.

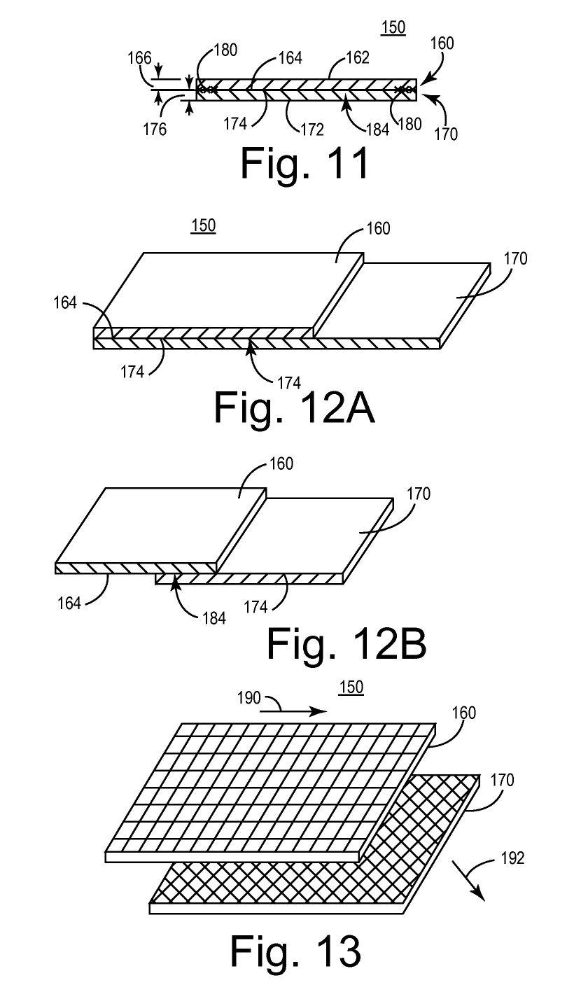

The battery cell generally includes electrical connections 140 (as shown in FIGS. 5 and 6 for example) extending from one or more anodes and cathodes. These electrical connections 140 are typically coupled to lead wires that pass through the encasement to the outside of the cell. A lead wire is electrically isolated from the encasement by a feed-through. In one embodiment, the feed-through is constructed of a glass insulator that seals the lead wire to the encasement while maintaining electrical isolation between the lead wire and the encasement. Other feed-through designs may include epoxy seals, ceramic seals, O-ring compression seals, riveted compression seals, or any other design known in the art. The feed-through, in addition to electrically isolating the lead wire from the encasement, substantially prevents material, such as the liquid electrolyte from leaking out of the encasement. The feed-through also substantially prevents foreign substances from entering into the encasement, thus reducing the likelihood of contamination of the capacitor internal components. FIG. 11 is a side view of layered separator 150 that may be used in any of the battery cell embodiments described herein. In FIG. 12, layered separator 150 includes two layers 160 and 170. Layers 160 and 170 may be formed from similar or dissimilar materials. In one embodiment, one layer 160 is formed from a paper, such as kraft paper, or Manila paper, and the other layer 170 is formed from a polymeric material, including non-woven polymers and microporous polymer membranes. In other embodiments, both layers 160 and 170 are formed from polymeric materials, which may be the same or different materials. Among the polymeric materials that may be used are polyesters, polystyrenes, aromatic polyesters, polycarbonates, polyolefins, polyethylene, polyethylene terephthalate, polypropylene, vinyl plastics such as polyvinyl difluoride, and cellulose esters such as cellulose nitrate, cellulose butyrate, and cellulose acetate. While only two layers 160 and 170 are shown in FIG. 12, it is recognized that in other embodiments a layered separator may be fabricated using three or more layers of separator materials wherein at least one layer is formed from a different material than the remaining layers. A different material includes a material having the same composition as the remaining layers but is provided with a different thickness and/or orientation based on an anisotropic property of the material.

Separator layer 160 is provided with an outer surface 162 and an inner surface 164 separated by a separator layer thickness 166. Inner surface 164 interfaces with the inner surface 174 of adjacent separator layer 170. Separator layer 170 is also provided with an outer surface 172 separated from inner surface 174 by separator layer thickness 176. If additional layers are included, outer surface 162 and/or outer surface 172 may interface with another adjacent layer.

The layers of layered separator 150 may be laminated together by adhering or bonding at least a portion of the interface 184 of inner surface 164 of layer 160 and inner surface 174 of layer 170. In the embodiment shown, a boundary area 180 along interface 184 is laminated to form layered separator 150. Alternatively, the entire interface 184 of the adjacent inner surfaces 164 and 174 may be laminated. Acceptable methods for laminating separator layers 160 and 170 may include pressing, heat lamination using any acceptable thermal source including a laser source, or using an ion conducting adhesive. The appropriate method for joining separator layers 160 and 170 to form a laminated layered separator 150 will depend on the types of materials selected.

In one embodiment, layer 160 includes a thickness 166 that is different than the thickness 176 of layer 170. Layer 160 and layer 170 may be formed from the same material but with different wall thicknesses. For example, one layer 160 or 170 may be provided as a sacrificial outer layer of the electrode subassembly 100. For example, in the battery cell, an outer separator layer may be more likely to be subjected to heating during welding of the encasement and the fill port. As such, the outer separator layer may be provided as a thin, sacrificial layer of the same material used to form the inner separator layer. Alternatively, the outer separator layer may be provided as a different material than inner separator layer. The outer separator layer may be fabricated from a material having higher thermal resistivity than inner separator layer.

A material having the thermal properties desired to withstand heating associated with welding steps used in manufacturing the battery cell may not have the electrical properties desired, such as porosity, tortuosity and wettability, which achieve a low contribution to ESR. In order to realize the electrical, mechanical and thermal properties desired of layered separator 150, one layer 170 may be provided with the thermal properties desired and the other layer 160 may be provided with the electrical properties desired. As such, selection of the materials used for separator layers 160 and 170 and their thicknesses 166 and 176 allows for improved performance of separator 150. Improved performance may include any of a decreased ESR, increased volume efficiency, improved reliability against internal short-circuit, and ease of manufacturing.

Layered separator properties contributing to a reduced ESR include a reduced separator thickness, reduced tortuosity, increased porosity, and/or increased wettability by the electrolyte. A material having a reduced defect density allows thinner or fewer separator layers to be used, contributing to reduced ESR without compromising reliability. Separator layers that have a reduced degree of bonding or interaction with the electrolyte will promote electrolyte diffusivity through the separator, contributing to a decrease in ESR. In one embodiment, separator layer 160 may be provided as a material having a high porosity but with a relatively high defect density requiring a relatively thick layer or multiple layers if used by itself. Separator layer 160 may be layered with or laminated to separator layer 170 formed from a relatively thin, low defect density material. Laminated separator 150 reduces ESR by using a high porosity layer 160 and improved reliability by using a low defect density layer 170.

Among the layered separator properties contributing to improved volume efficiency are the thickness and number of layers used to form layered separator 150. Material properties affecting the thickness and number of separator layers required include electrical properties such as dielectric constant and porosity; material stability in electrolyte; thermal properties (e.g. heat capacity), heat of fusion, thermal resistivity and melting point, and mechanical properties (e.g. defect density, resistance to perforation, tensile strength and shear strength, etc.) In one embodiment, separator layer 160 is provided with desirable electrical properties (e.g., thin, high porosity, low tortuosity, etc.), and separator layer 170 is provided with desirable mechanical and thermal properties (e.g., low defect density, high thermal resistivity, high tensile strength, etc.). In another embodiment, one separator layer 160 may include desirable mechanical properties such that it acts as a mechanical barrier against shock and vibration during handling and use. Another separator layer 170 is provided with desirable thermal properties such that it acts as a thermal barrier during welding of the battery cell encasement. In one specific example, separator layer 160 is fabricated from Celgard 5550 and separator layer 170 is fabricated from GORE EXCELLERATOR. The two materials may be laminated together, for example along the outer borders of a common interface using a heat seal band.

Reducing separator swelling that occurs in the presence of a liquid electrolyte also contributes to battery cell volume efficiency. In one embodiment, separator layer 160 is fabricated from a material having desirable electrical properties, such as kraft paper, but may swell in the presence of the electrolyte. Separator layer 170 is provided as a non-swelling material, such as GORE EXCELLERATOR, that contributes to improving the overall volumetric efficiency by reducing the total swelling that occurs.

Depending on the battery cell configuration in which layered separator 150 is used, one layer 160 may be an inner layer and one layer 170 may be an outer layer after assembling layered separator 150 with an anode and cathode in an electrode subassembly or within the battery cell encasement. Examples of configurations which result in an outer separator layer 170 and an inner separator layer 160 are shown in the embodiment of FIG. 11 or in the coiled configurations shown in FIGS. 5 and 6. Layered separator 150 may therefore be designed such that an outer layer 170 is characterized by properties desirable on the outer layer, such as high heat capacity and melting point to withstand welding of the cell encasement.

FIG. 12A is a perspective view of a layered separator that includes two layers 160 and 170 in which one layer 170 is provided with a greater length than the other layer 160. The inner surface 164 of layer 160 is disposed adjacent a portion of inner surface 174 of layer 170 forming an interface 184. Layer 160 and layer 170 may be laminated together along any portion or all of interface 184.

FIG. 12B is a perspective view of a separator 150 that includes two layers 160 and 170 that overlap over a portion of their inner surfaces 164 and 174 forming interface 184. The two layers 160 and 170 may be laminated over any portion or all of interface 184. Depending on the battery cell configuration, one set of separator properties may be desirable over one portion of the separator and another set of separator properties may be desirable over another portion of the separator. As such, separator layers 160 and 170 included in a layered separator 150 may be provided with different lengths and/or widths, as shown in the examples of FIGS. 12A and 12B, such that the resulting layered separator properties are heterogeneous. For example, in a coiled configuration, a separator layer 170 that forms an outer coil wrap may extend beyond the end of another separator layer 160 that forms an inner separator layer. The outer separator layer 170 may provide thermal or mechanical properties desirable of an outer layer while the inner separator layer 160 provides desirable electrical properties.

FIG. 13 is a perspective, exploded view of a layered separator 150 illustrating different orientations of separator layers 160 and 170. In some embodiments, materials used for layers 160 and 170 may have isotropic properties such that any orientation of the layers 160 and 170, including a random orientation, with respect to each other and the overall battery cell configuration is acceptable.

In other embodiments, the material selected for layer 160 and/or layer 170 may possess anisotropic properties such that the orientation of the layer 160 and/or 170 with respect to other separator layers and/or the overall battery cell configuration influence separator performance. In one embodiment, layers 160 and 170 are fabricated from the same material possessing an anisotropic property. Layer 170 is aligned with layer 160 at an angled orientation, indicated generally by arrow 192, with respect to the orientation of layer 160, indicated generally by arrow 190. The orientations of layers 160 and 170 are based on the anisotropic property of the material selected for layers 160 and 170. For example, orienting layer 160 in one direction and layer 170 in a different direction may provide increased tensile strength of layered separator 150 in two directions, even when layer 160 and layer 170 are formed from the same material.

Alternatively, layer 160 and layer 170 may be formed from dissimilar materials wherein one layer possesses an anisotropic property. Layer 160 may be provided as a material having isotropic properties and therefore may be randomly oriented, while layer 170 is provided as a material having anisotropic properties. Layer 170 is oriented in a desired direction to utilize the anisotropic property in realizing desired physical properties of layered separator 150. The orientation of a particular material may be determined according to an anisotropic property or the direction of the weave of a woven material.

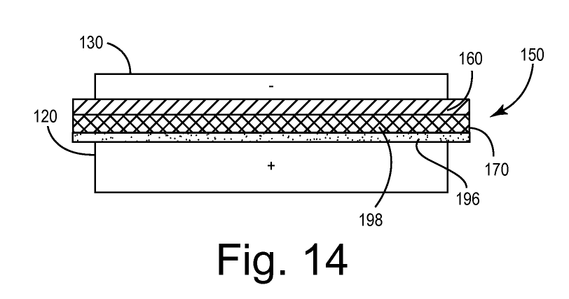

FIG. 14 is a side sectional view of an alternative embodiment of a layered separator disposed between a cathode 130 and an anode. Separator 150 includes two layers 160 and 170 wherein one layer 170 is a laminated layer and layer 160 is a single layer. Laminated layer 170 includes two sub-layers 196 and 198 which are laminated together to from layer 170. Sub-layers 196 and 198 may be formed from any paper or polymeric materials as described previously. Laminated layer 170 is aligned and stacked with single layer 160 to form layered separator 150. Laminated layer 170 and single layer 160 may also be laminated together over any portion of the interface formed between layers 160 and 170 as described previously.

With respect to the physical properties, Tables 1 and 2 list an acceptable range for each property. Either the first or the second separator layers may rely on these physical property ranges. The first range provides desirable characteristics whereas the second range includes broader ranges that may be implemented.

TABLE 1
Physical Property Ranges for PTFE

| Property - GORE | First range | Second range |
|---|---|---|
| Thickness (um, in) | 25 ± 3 um | 1-100 um |
| | 0.0010 ± 0.0001 in | |
| Width (mm, in) | 63.5 ± 2.5 mm | n/a (any) |
| | 2.5 ± 0.1 in | |
| Porosity (%) | 20 + 15/−10 sec | 1-60 |
| Melt Temperature | 326-340° C. | 70-400 depending on |
| (° C.) | | choice of other |
| | | material. |
| Wettability | DI Water Wettable - Yes | All of the above. |
| (Presence of Wetting | Oil - (Information Only) | |
| Agent) | | |
| Axial Tensile Strength | 2,200 ± 400 | 100-infinity (any) |
| (psi) | | |
| Cross-Web Tensile | 4,500 ± 500 | 100-infinity (any) |
| Strength (psi) | | |

TABLE 2
Physical Property Ranges for Polypropylene

| Property - Polypropylene | First range | Second range |
|---|---|---|
| Thickness | | |
| (um) | 76.2-149.9 | 1-1000 um |
| (in) | .0030″-.0059″ | |
| Width | | |
| (mm) | 63.5 ± 2.5 | n/a |
| (in) | 2.5 ± 0.1 | |
| Porosity (%) | 8.0 + 2.0/−1.0 | 1-60 |
| Melt Temperature (° C.) | (155° C.-170° C.) | any |
| Wettability | DI Water Wettable - Yes | All of the above. |
| (Presence of Wetting | Oil - (Information Only) | |
| Agent) | | |
| Axial Tensile Strength | 20,700 ± 2000 | 100-infinity |
| (psi) | | |
| Cross-Web Tensile | 20,900 ± 2000 | 100-infinity |
| Strength (psi) | | |

The present invention also provides methods for making a battery cell. The method includes fabricating a layered separator and positioning the separator material between one or more pairs of alternating cathode and anode plates or layers so that a separation is maintained between the anode and cathodes. Fabrication of a layered separator may include steps of cutting or otherwise forming two or more separator layers, aligning the layers to interface over a desired surface area, and optionally laminating the layers over at least a portion of the interfacing areas. Forming the separator layers may include die cutting or any other suitable cutting method. Additionally or alternatively, the separator may be formed to a desired shape after laminating the layers together. A laminated separator may be formed to a desired shape using die cutting any other suitable cutting methods.

Lamination of the separator layers may include using heat, pressure, or chemical adhesives. Although the separator layers may be laminated together in one step over one continuous interface area, it is recognized that separator layers may be laminated together over two or more discreet interfacing areas in one or more laminating steps. A laminated interface may or may not incorporate all layers of the separator. For example, a portion of an interface between a first and second layer may be laminated to bond or adhere the first and second layers together. Another interface between the second layer and a third layer may be laminated to bond or adhere the second and third layer together to form a laminated separator having three layers.

In positioning the separator between the anode and cathode, it is important to maintain proper alignment of all anode, cathode, and separator components. Failure to do so can lead to short-circuiting or inefficient capacitor performance. In some embodiments, an anode/separator/cathode subassembly is assembled and then positioned in an encasement which is sealed closed and filled with a suitable electrolyte. The subassembly may be a coiled or stacked subassembly as described previously. In other embodiments, the battery cell assembly method may include assembling an anode/separator subassembly by sealing or wrapping the anode in the layered separator. The anode/separator subassembly is placed in an encasement in which cathode material is operatively disposed relative to the anode, for example deposited on interior walls of the encasement. The encasement is sealed closed and filled with a suitable electrolyte. In still other embodiments, a method for making a battery cell may include enclosing either or both anode and cathode elements in a layered separator, then assembling an electrode subassembly using the cathode/separator subassembly and anode material.

Co-pending U.S. patent application Ser. No. 11/363,610, entitled “SEPARATOR LAYER SYSTEMS FOR ELECTROCHEMICAL CELLS”, filed by John D. Norton et al. and assigned to the same Assignee as the present invention, describes separators for capacitors. This co-pending application is hereby incorporated herein by reference.

Thus, electrochemical cells having a layered separator and methods for manufacturing have been presented in the foregoing description with reference to specific embodiments. It is appreciated that various modifications to the referenced embodiments may be made without departing from the scope of the invention as set forth in the following claims.

What is claimed:

1. A battery cell comprising:
an anode;
a cathode spaced from and operatively associated with the anode;
an electrolyte operatively associated with the anode and the cathode; and
a layered separator including a plurality of separator material layers disposed between the anode and cathode, wherein the plurality of separator material layers includes a first layer and a second layer, the first layer characterized by a first anisotropic property and the second layer characterized by a second anisotropic property, the second anisotropic property being a different physical property than the first anisotropic property,
the first layer having a first orientation based on a direction of the first anisotropic property and the second layer having a second orientation relative to the first layer based on a direction of the second anisotropic property such that the orientation of the first layer and the orientation of the second layer influence separator performance.

2. The battery cell of claim 1 wherein the first layer includes a polymer material.

3. The battery cell of claim 1 wherein at least one of the plurality of separator material layers being formed from a material substantially non-swelling in the presence of the electrolyte.

4. The battery cell of claim 1 wherein the first layer is provided with a first outer dimension and the second layer is provided with a second outer dimension different than the first outer dimension, the first and second outer dimensions being one of a length and a width.

5. An implantable medical device, comprising:
a battery cell including an anode and a cathode separated by a separator disposed between the anode and cathode including a plurality of separator material layers, wherein the plurality of separator material layers includes a first layer and a second layer wherein the first layer being characterized by a first anisotropic property and the second layer being characterized by a second anisotropic property;
a capacitor;
charging circuitry coupled to the battery cell and the capacitor;
output circuitry coupled to the capacitor; and
control circuitry for controlling the charging circuitry for charging of the capacitor and for controlling discharge of the capacitor through the output circuitry
the first separator layer having a first orientation based on a direction of the first anisotropic property and the second separator layer having a second orientation relative to the first layer based on a direction of the second anisotropic property such that the orientation of the first layer and the orientation of the second layer influence separator performance,
the second anisotropic property being a different physical property than the first anisotropic property.

6. The medical device of claim 5 wherein the first layer and the second layer form an interface and the first layer and the second layer are laminated along at least a portion of the interface.

7. The medical device of claim 5 wherein the first layer includes a polymer material.

8. The medical device of claim 5 wherein at least one of the plurality of separator material layers is formed from a material that is substantially non-swelling in the presence of the electrolyte.

9. The medical device of claim 5 wherein the first layer includes a first outer dimension and the second layer includes a second outer dimension different than the first outer dimension, the first and second outer dimensions being one of a length and a width.

10. A method for manufacturing a battery cell comprising:
selecting a first separator layer having a first anisotropic property;
selecting a second separator layer having a second anisotropic property;
aligning the first separator layer and the second separator layer to form a layered separator; and
disposing the layered separator between an anode and a cathode,
the first layer aligned having a first orientation based on a direction of the first anisotropic property and the second layer aligned having a second orientation relative to the first layer based on a direction of the second anisotropic property such that the orientation of the first layer and the orientation of the second layer influence separator performance,
the second anisotropic property being a different physical property than the first anisotropic property.

11. The method of claim 10 further including laminating the layered separator over at least a portion of an interfacing surface disposed between the first separator layer and the second separator layer.

12. The battery cell of claim 4 wherein the layered separator having heterogeneous electrical properties along one of the length and the width.

13. The battery cell of claim 1 wherein the first layer being an outer layer after assembling the layered separator within a battery cell encasement.

14. The battery cell of claim 13 wherein the first layer having a first tensile strength and the second layer having a second tensile strength less than the first tensile strength.

15. The battery cell of claim 1 wherein the first layer comprising a first material and the second layer comprising a second material having the same composition as the first material.

16. The battery cell of claim 1 wherein the first layer and the second layer being dissimilar materials.

17. A battery cell comprising:
an anode;
a cathode spaced from and operatively associated with the anode;
an electrolyte operatively associated with the anode and the cathode; and
a layered separator including a plurality of separator material layers disposed between the anode and cathode, wherein the plurality of separator material layers includes a first layer and a second layer, the first layer characterized by a first anisotropic property and the second layer characterized by a second anisotropic property, the second anisotropic property being a different physical property than the first anisotropic property,
the first layer having a first orientation based on a direction of the first anisotropic property and the second layer having a second orientation relative to the first layer based on a direction of the second anisotropic property such that the orientation of the first layer and the orientation of the second layer influence separator performance,
wherein the first layer is provided with a first outer dimension and the second layer is provided with a second outer dimension different than the first outer dimension, the first and second outer dimensions being one of a length and a width.
